(19) United States
(12) Patent Application Publication
(10) Pub. No.: US 2024/0101827 A1
(43) Pub. Date: Mar. 28, 2024

(54) COMPOSITIONS FOR PRODUCING SEALING MEMBRANES, AND ASSOCIATED METHODS AND MEMBRANES

(71) Applicant: TOTALENERGIES ONETECH, Courbevoie (FR)

(72) Inventors: Julie PREVOST, Solaize Cedex (FR); Jean-Philippe PAILLAC, Solaize Cedex (FR)

(73) Assignee: TOTALENERGIES ONETECH, Courbevoie (FR)

(21) Appl. No.: 18/262,589

(22) PCT Filed: Jan. 28, 2022
(86) PCT No.: PCT/FR2022/050161

§ 371 Date: Jul. 24, 2023

(30) Foreign Application Priority Data
Jan. 28, 2021 (FR) FR2100809

(51) Int. Cl. C08L 95/00; C08K 3/013

(52) U.S. Cl. CPC C08L 95/00; C08K 3/013; C08K 2201/005; C08L 2555/50; C08L 2555/84

(57) ABSTRACT

The present invention relates to a bituminous composition suitable for forming sealing membranes comprising, in bitumen-based matrix, fillers C that represent 21 to 40% of the total mass of the composition and that are constituted of inorganic particles Ci and polymeric particles Cp of crystal polystyrene or high-impact polystyrene, the mass of polymeric particles Cp representing 1 to 10% of the total mass of the composition and the mass of bitumen representing 40 to 70% of the total mass of the composition. The invention also relates to the method for obtaining such compositions and to the sealing membranes obtained with them.

### TECHNICAL FIELD

The present invention relates to the field of sealing membranes and bituminous compositions suitable for their manufacture.

### PRIOR ART

Many construction elements must be protected against humidity and/or water coming, particularly, from bad weather. For this purpose, sealing membranes have been proposed for internal and external uses and, in particular, for covering roofs of houses or buildings. Such sealing membranes in the form of films, that are often multi-layered, produced in place or beforehand in the form of rolls, are described in the prior art. A certain number of bitumen-based solutions have emerged. During the last decades, various compositions for forming sealing membranes, based on bitumen modified by one or more polymers, of the type consisting of poly(ethylene-vinyl acetate) (EVA), atactic polypropylene (aPP), copolymers with styrene-butadiene-styrene (SBS) blocks, have been developed (Diani E, et al., “Styrenic block copolymers as bitumen modifiers for improved roofing sheets”, Rubber World, 206, 1992, pages 44-48; Rodriguez I, et al., “Effect of heat-aging on the thermal and mechanical properties of APP- and SBS-modified bituminous roofing membranes”, Mater. Struct., 26, 1993, pages 355-361; Wloczysiak P, et al, “Relationships between Rheological Properties, Morphological Characteristics, and Composition of Bitumen-Styrene Butadiene Styrene Copolymers Mixes. I. A Three-Phase System”, J. Appl. Polym. Sci. 65, 1997, page 1595; Fawcett A H, et al., “Blends of bitumen with various polyolefins”, Polymer, 41, 2000, pages 5315-5326; Fawcett A H, et al., “Studies on Blends of Acetate and Acrylic Functional Polymers with Bitumen”, Macromol. Mater. Eng., 286, 2001, pages 126-137; Airey GD “Rheological evaluation of ethylene vinylacetate polymer modified bitumens”, Construction and Building Materials, 16, 2002, pages 473-487). Indeed, the viscoelasticity of bitumen makes it entirely suitable for this type of application and the addition of such polymers can improve the rheological and mechanical properties of the membrane obtained, and particularly its flexibility and its pliability at low temperature. More recently, inorganic fillers such as calcium carbonate have also been added to the compositions in order to form sealing membranes (Techniques de l'ingénieur, Ref C5438 V1, Comparaison des geomembranes, 10 Aug. 2015, by Jean-Pierre Giroud). Such membranes are proposed, in particular, by Soprema under the the names Elastophene Flam® and Sopralene Flam® (https://www.sic-34.fr/wp-content/uploads/sites/5350/2018/01/5-09-2068-DTA-Elastophene-Flam-Sopralene-Flam.pdf).

Application EP 1698669 can also be cited, which proposes a bituminous elastomer binder for sealing membranes, comprising a bitumen, one or more polymers which comprise at least styrene-butadiene-styrene (SBS) and one or more mineral fillers comprising at least one phyllosilicate, the SBS/phyllosilicate mixture constituting between 3 and 20% by weight of said bituminous binder and the fraction of said phyllosilicate representing between 5 and 25% by weight of said SBS. The proposed solution is presented as a solution that can reduce the cost price of the bituminous composition and thus of the sealing membrane obtained.

In the context of the invention, it is proposed to provide alternative compositions to those proposed in the prior art, for forming sealing membranes, in particular for a roof. The compositions and manufacturing methods for such compositions offer novel possibilities for recycling plastic waste, and are therefore particularly advantageous from an ecological point of view and in order to reduce the carbon footprint. The compositions and membranes according to the invention offer novel solutions for reducing their cost price. Another object of the invention is, likewise, to provide compositions which can reduce the weight of the sealing membranes obtained with such compositions, which is advantageous, particularly for facilitating their handling and transport.

### DISCLOSURE OF THE INVENTION

The invention relates to a bituminous composition comprising, in a bitumen-based matrix, fillers C that represent 21 to 40% of the total mass of the composition and that are composed of inorganic particles Ci and polymer particles Cp of crystal polystyrene or high-impact polystyrene, the mass of polymer particles Cp representing 1 to 10% of the total mass of the composition and the mass of bitumen representing 40 to 70% of the total mass of the composition.

In the context of the invention, it has been shown that the replacement of inorganic fillers Ci by selected polymer particles Cp which are particles of high-impact or crystal polystyrene, in a bituminous composition intended for the manufacture of a sealing membrane, does not lead to any loss of the properties of the sealing membrane obtained. In particular, the compositions and membranes obtained have been evaluated in terms of penetrability at 20 and 50° C., of ring and ball softening temperature (TBA), of pliability when cold, before and after long-term accelerated ageing in a pressure ageing vessel (PAV), of remanence Re and viscosity. It was found that at equal mass % of fillers C, the substitution of part of the inorganic fillers Ci by selected polymer fillers Cp within the context of the invention does not lead to loss of these properties, which remain substantially identical. The invention also makes it possible to use, as fillers, polymer particles from plastic waste recycling, which opens routes for recycling waste, enabling the environmental footprint of the sealing membranes obtained with the compositions according to the invention to be reduced, promoting a circular economy and limiting the use of finite resources such as inorganic fillers. Moreover, such a replacement of a part of the inorganic fillers Ci by selected polymer fillers Cp in the context of the invention makes it possible to reduce the weight of the sealing membrane obtained.

In particular, the high-impact or crystal polystyrene of the polymer particles Cp has a Mw in the range from 80 to 300 kg/mol, and preferably in the range from 100 to 250 kg/mol.

In a preferred manner, the polymer particles Cp comprise at least 85% by mass, preferably at least 90% by mass, and more preferably at least 95% by mass of high-impact or crystal polystyrene; said high-impact or crystal polystyrene is in a mixture with one or more polymers P1, preferably chosen from polyvinyl chloride (PVC), acrylonitrile-butadiene-styrene (ABS) copolymer, polycarbonates and polyethylene terephthalate (PET). Advantageously, such polymer particles Cp preferably come from waste recycling.

Advantageously, the compositions according to the invention further comprise, as additional component(s), one or more polymers P2, preferably chosen from plastomers and thermoplastics and, particularly, thermoplastic elastomers, in particular chosen from copolymers with unsaturated blocks. In particular, the one or more polymers P2 are chosen from styrene-butadiene-styrene block copolymers, preferably in branch or star-shaped form, atactic polypropylene and poly(ethylene vinyl acetate).

Preferably, the mass of polymer(s) P2 represents 5 to 25%, preferably 5 to 20% and, yet more preferably, 7 to 18% of the total mass of the composition.

In particular, the inorganic particles Ci are particles of calcium carbonate, magnesium carbonate, magnesium hydroxide, calcium sulfate, barium sulfate, silica, clay, talc, mica, wollastonite, montmorillonite, zeolite, alumina, titanium oxide, magnesium oxide, zinc oxide or glass; particles of calcium carbonate being preferred.

Preferably, the mass of inorganic particles Ci represents 20 to 39%, preferably 25 to 37%, and yet more preferably 27 to 34% of the total mass of the composition.

Advantageously, the D50 of the polymer particles Cp and/or the D50 of the inorganic particles Ci is in the range from 10 to 300 μm, preferably in the range from 20 to 200 μm, and more preferably in the range from 30 to 150 μm.

The preferred compositions, in the context of the invention, comprise, or even are composed of:
21 to 40% m/m, preferably 26 to 38% m/m, and yet more preferably 28 to 35% m/m of fillers C, composed of inorganic particles Ci and polymer particles Cp of high-impact or crystal polystyrene, the polymer particles Cp representing 1 to 10% m/m, preferably 1 to 5% m/m, and yet more preferably 1 to 3% m/m of the total mass of the composition and the inorganic particles Ci representing 20 to 39% m/m, preferably 25 to 37% m/m, and yet more preferably 27 to 34% m/m of the total mass of the composition;
40 to 70% m/m, preferably 50 to 65% m/m, and yet more preferably 55 to 65% m/m of bitumen;
5 to 25% m/m, preferably 5 to 20% m/m, and yet more preferably 7 to 18% m/m of one or more polymers P2 as defined in the context of the invention; the % m/m being % by mass relative to the total mass of the composition.

Another object of the invention is a method for preparing a composition according to the invention, comprising mixing under heating of an assembly comprising:
bitumen, and
fillers C composed of inorganic particles Ci and polymer particles Cp of high-impact or crystal polystyrene.

In particular, the mixing under heating is carried out at a temperature in the range from 100 to 220° C., preferably for 5 minutes to 10 hours and/or under stirring from 200 to 2000 rpm.

Advantageously, the mixing under heating is performed on an assembly comprising, additionally, one or more polymers P2 chosen from plastomers and thermoplastics and, particularly, thermoplastic elastomers, in particular chosen from copolymers with unsaturated blocks, and, yet more preferably, chosen from styrene-butadiene-styrene block copolymers, preferably in branched or star-shaped form, atactic polypropylene and poly(ethylene-vinyl acetate).

Preferably, the method according to the invention also comprises introducing, into the bitumen, said one or more polymers P2, before introducing, into the bitumen, inorganic particles Ci and polymer particles Cp of high-impact or crystal polystyrene.

Advantageously, the method according to the invention comprises introducing, into the bitumen, inorganic particles Ci which have a D50 that is in the range from 10 to 300 μm, preferably in the range from 20 to 200 μm, and more preferably in the range from 30 to 150 μm and/or polymer particles Cp of high-impact or crystal polystyrene which have a D50 in the range from 10 to 300 μm, preferably in the range from 20 to 200 μm, and more preferably in the range from 30 to 150 μm.

The use of compositions according to the invention for manufacturing a sealing membrane, in particular for a roof, is an integral part of the invention. Also, according to another of its aspects, the invention relates to a sealing membrane, in particular for a roof, comprising a layer formed of a composition according to the invention.

Another object of the invention is the sealing membranes, in particular for a roof, comprising a composition according to the invention, being at least partially impregnated with a fibrous material.

In particular, the invention relates to such sealing membranes being in the form of a multilayer structure.

### Definitions and Methods

D50 is defined as being the diameter of particles for which 50% by volume of the particles have a diameter greater than this value and 50% by volume of the particles have a diameter less than this value. D50 is determined, in the context of the invention, using a laser diffraction particle size analyser, by the liquid method (alcohol). The extent of the distribution, or polydispersity, is characterised by the coefficient of variation (CV) defined according to the relation: CV=(D90-D10)/D50 where D90 is defined as being the diameter of particles for which 10% by volume of the particles have a diameter greater than this value and 90% by volume of the particles have a diameter less than this value, and D10 is defined as being the diameter of particles for which 90% by volume of the particles have a diameter greater than this volume and 10% by volume of the particles have a diameter less than this value. When a particle is not perfectly spherical, the diameter is the mean diameter of the particle.

The average molecular masses can be measured by gel permeation chromatography (GPC), also known as size exclusion chromatography (SEC). SEC is a liquid chromatography method in which the polymers are separated according to their hydrodynamic volume, which is then converted by conventional external calibration into weight average molecular mass (Mw). The external standard used to determine the Mw of polystyrene is a polystyrene standard.

The standards mentioned in the context of the invention correspond to the version in force on the first of January 2021, unless otherwise specified.

### Bitumens

The compositions according to the invention contain a single bitumen or a mixture of bitumens. Among the bitumens that can be used in the compositions according to the invention, mention may be made first of all to bitumens of natural origin, those contained in natural bitumen or natural asphalt deposits or bituminous sands and bitumens originating from the refining of crude oil. In the context of the invention, the bitumen or bitumens present in the composition are advantageously chosen from bitumens coming from the refining of crude oil, in particular bitumens containing asphaltenes or pitches. The bitumens can be obtained by conventional processes for manufacturing bitumens in refining, in particular by direct distillation and/or vacuum distillation of crude oil. These bitumens can optionally be visbroken and/or deasphalted and/or air-rectified. It is common practice to vacuum-distil the atmospheric residues originating from the atmospheric distillation of crude oil. This manufacturing process consequently corresponds to the sequence of an atmospheric distillation and a vacuum distillation, the feedstock feeding the vacuum distillation corresponding to the atmospheric residues. These vacuum residues from the vacuum-distillation tower can also be used as bitumens. It is also common practice to inject air into a feedstock usually composed of distillates and heavy products originating from the vacuum distillation of atmospheric residues originating from the distillation of oil. This process makes it possible to obtain a blown, or semi-blown or oxidised or air-rectified or partially air-rectified bitumen. Various bitumens obtained by the refining processes can be combined in the compositions according to the invention, in order to obtain the best compromise in terms of technical performance. In conventional methods the mixing of different bitumens is carried out at temperatures between 100° C. and 200° C., preferably between 140° C. and 200° C., and with stirring for a period of at least 10 minutes, preferably between 30 minutes and 10 hours, more preferably between 1 hour and 6 hours. The heating temperature and time vary according to the amount of bitumen used and are defined by standard NF EN 12594. The blown bitumens can be manufactured in a blowing unit, by passing a stream of air and/or oxygen through a bitumen or starting mixture of bitumens. This operation can be carried out in the presence of an oxidation catalyst, for example phosphoric acid. Generally, the blowing is carried out at high temperatures, of about 200 to 300° C., for relatively long periods of time, typically of between 30 minutes and 2 hours, continuously or batchwise. The blowing time and temperature are adjusted according to the properties targeted for the blown bitumen and according to the quality of the starting bitumen.

The bitumens that can be used according to the invention include bitumens from recycling.

The bitumens can be hard grade bitumens (such as grades 10/20 and 20/30) or soft grade bitumens (such as grade 160/220) defined by the standard EN 12591.

The invention is particularly suitable for the case where the composition is formed with a bitumen chosen from bitumens of grades 160/220 and 70/100 and the mixtures thereof. The bitumens that can be used in the context of the invention have, preferably, a penetrability measured at 25° C. according to standard EN 1426, of 5 to 330 1/10 mm, preferably between 10 to 220 1/10 mm. In known manner, the so-called “needle penetration” measurement is carried out by means of a standardised test NF EN 1426 at 25° C. (Pene). This penetration characteristic is expressed in tenths of a millimetre (dmm or 1/10 mm). The needle penetration, measured at 25° C. according to the standardised test NF EN 1426, represents the measurement of penetration into a bitumen sample, after a time of 5 seconds, of a needle with a weight with its support of 100 g.

### Fillers C

The compositions according to the invention comprise fillers which are distributed in the bitumen or more generally in a matrix formed of one or more bitumens, or even a bitumen(s)/polymer(s) mixture P2 defined in the context of the invention. The fillers C in the context of the invention are of two types: one part consists of inorganic particles or fillers, denominated Ci, the other part consists of polymer particles or fillers of high-impact or crystal polystyrene, denominated Cp. These two types of particles are defined in a more detailed manner in the description below. In the context of the invention, it has been shown that a part of the mineral fillers used in the compositions of the prior art could be replaced by polymer fillers Cp and that this would not alter the properties evaluated in the examples of the membranes obtained. It is thus possible to use, as fillers, polymer particles Cp composed of or mostly composed of a crystal or high-impact polystyrene. This therefore opens up many possibilities for using polymer fillers from plastic waste recycling, and particularly recycled polystyrene waste.

In the context of the invention, the fillers C present in the composition, which serve as polymer particles Cp or inorganic particles Ci, are, preferably, of micrometre size and particularly have a maximum size less than or equal to 500 μm. When a particle is perfectly spherical, its maximum size is its diameter. In a preferred manner, the polymer particles Cp and/or the inorganic particles Ci have a D50 in the range from 10 to 300 μm, preferably in the range from 20 to 200 μm, and more preferably in the range from 30 to 150 μm.

Advantageously, the polymer particles Cp present in the composition have a coefficient of variation CV, characterising their size dispersion, from 1.1 to 5, preferably from 1.1 to 4, and more preferably from 1.1 to 3 and/or the inorganic particles Ci present in the composition have a coefficient of variation CV, characterising their size dispersion, from 1.1 to 5, preferably 1.1 to 4, and more preferably from 1.1 to 3.

Inorganic fillers Ci having such a size are commercially available. However, the size of polymer particles Cp and inorganic particles Ci introduced could be adjusted according to all the conventional techniques that are well known to a person skilled in the art. In particular, a grinding operation is carried out followed by particle size selection by passage through one or more sieves. In the case of polymer particles Cp, obtained from plastic waste, a course chip-cutting operation is generally carried out, before a finer grinding operation.

Thus, the compositions according to the invention can be obtained by introducing, into a bitumen-based matrix, polymer particles Cp having a D50 that is in the range from 10 to 300 μm, preferably in the range from 20 to 200 μm, and more preferably in the range from 30 to 150 μm, and inorganic particles Ci having a D50 in the range from 10 to 300 μm, preferably in the range from 20 to 200 μm and more preferably in the range from 30 to 150 μm. The polymer particles Cp and the inorganic particles Ci that are introduced can, however, have the same or different size.

Advantageously, the compositions according to the invention can be obtained by introducing, into a bitumen-based matrix, polymer particles Cp having a coefficient of variation CV, characterising their size dispersion, from 1.1 to 5, preferably from 1.1 to 4, and more preferably from 1.1 to 3 and/or inorganic particles Ci having a coefficient of variation CV, characterising their size dispersion, from 1.1 to 5, preferably from 1.1 to 4, and more preferably from 1.1 to 3.

### Polymer Particles Cp

The polymer particles Cp are high-impact or crystal polystyrene particles. The high-impact and crystal polystyrenes are well-known polymers, which differ from expanded polystyrene. Crystal polystyrene is transparent and is a homopolymer of styrene. High-impact polystyrene (also known as HIPS) contains a portion of polybutadiene and is defined, in particular, in standard EN ISO 1043-1.

The polymer particles Cp are composed or mainly composed of crystal or high-impact polystyrene, which does not exclude the presence of one or more components or impurities in said particles. However, the polymer particles Cp comprise at least 85% by mass, preferably at least 90% by mass, and preferably at least 95% by mass, high-impact or crystal polystyrene.

In addition, the polymer particles Cp can comprise one or more polymers P1, preferably, chosen from the polyvinyl chloride (PVC), acrylonitrile-butadiene-styrene (ABS) copolymer, polycarbonates and polyethylene terephthalate (PET). Preferably, the mass of polymer(s) P1 present represents at most 15%, preferably, at most 10%, and more preferably at most 5% of the mass of the polymer particles Cp.

Preferably, the high-impact or crystal polystyrene of the polymer particles Cp has a Mw in the range from 80 to 300 kg/mol, and preferably in the range from 100 to 250 kg/mol. According to a particular embodiment, the polymer particles Cp comprise a high-impact or crystal polystyrene, advantageously having a Mw in the range from 80 to 300 kg/mol, and preferably in the range from 100 to 250 kg/mol, in a mixture with another polymer P1, and in particular in a mixture with an ABS copolymer. In particular, the polymer particles Cp consist of a crystal or high-impact polystyrene (and in particular a high-impact polystyrene having, preferably, a previously defined Mw) or a crystal or high-impact polystyrene/polymer P1 mixture (and, in particular, in which the polystyrene is a high-impact polystyrene, having, preferably, a previously defined Mw), and particularly a crystal or high-impact polystyrene/ABS mixture. In this case, preferably, the quantity of polymer P1, and in particular ABS, represents 5 to 15%, and preferably 8 to 12% of the mass of the polymer particles Cp. Such particles are particularly obtained from recycled polymer(s), particularly from packaging waste or waste from household electrical appliances such as refrigerators.

Furthermore, the polymer particles Cp can be composed of particles of the same type or particles of different types. It is, in particular, possible to use a mixture of high-impact polystyrene particles and crystal polystyrene particles. It is also possible that the composition comprises, as polymer particles Cp, particles composed of a high-impact or crystal polystyrene and particles composed of a mixture of a high-impact or crystal polystyrene and a polymer P1, as described above.

### Inorganic Particles Ci

The compositions according to the invention comprise inorganic particles Ci, which partially compose the fillers C. In the prior art, these inorganic particles are introduced into the compositions for sealing membranes in order to provide good walking resistance and creep resistance to the membranes obtained.

All inorganic particles used by a person skilled in the art in compositions suitable for producing sealing membranes can be used. The inorganic particles Ci are, advantageously, particles of calcium carbonate, magnesium carbonate, magnesium hydroxide, calcium sulfate, barium sulfate, silica, clay, talc, mica, wollastonite, montmorillonite, zeolite, alumina, titanium oxide, magnesium oxide, zinc oxide or glass. Preferably, the compositions according to the invention comprise calcium carbonate as inorganic particles Ci.

### So-Called Additional Polymers P2

Advantageously, the compositions according to the invention, further comprise, at least one additional component, in addition to bitumen, inorganic particles Ci and polymer particles Cp. As additional component, the compositions according to the invention advantageously comprise one or more polymers P2, qualified as additional polymers. Indeed this polymer or polymers P2 are called additional, because they do not correspond to the polymer or polymers present in the polymer particles Cp. Thus, a polymer P2 is not a high-impact polystyrene or a crystal polystyrene. Particularly preferred polymers P2 in the context of the invention include polymers chosen from plastomers, particularly polyolefins and olefin copolymers, such as poly(ethylene-vinyl acetate) (EVA) and atactic polypropylene (aPP), thermoplastics and, particularly, thermoplastic elastomers, in particular chosen from copolymers with unsaturated blocks. In bituminous compositions suitable for forming sealing membranes, it is conventional that such a polymer is used, in particular in order to confer a satisfactory flexibility and pliability to the membrane obtained. Typical examples of particularly preferred thermoplastic elastomers are styrene-butadiene-styrene (SBS) block copolymers, styrene-isoprene-styrene (SIS) or styrene-ethylene-butylene-styrene (SEBS), preferably in a radial or star-shaped form. Such polymers are widely available commercially, particularly from the companies Kraton or Evonik. By way of example, it is possible to use a copolymer with SBS blocks marketed under reference D1184 from Kraton or an aPP marketed under reference Vestoplast® 888 from Evonik.

### Compositions According to the Invention

The quantities of the various components present in a composition according to the invention are given in mass %, relative to the total mass of the composition (denoted hereinafter % m/m), at least if not otherwise specified.

The preferred quantities of the various components present in the compositions according to the invention are given below. These quantities can be used independent of one another. Of course, they can be used in combination and all of the possible combinations of the ranges specified below are possible in the context of the invention. By way of example, the broadest ranges of mass % given for each of the components will be used in combination, or else the intermediate mass % ranges given for each of the components can be used in combination, or else the most restricted mass % ranges given for each of the components can be used in combination.

The compositions according to the invention comprise 21 to 40% m/m fillers C, preferably 26 to 38% m/m, and yet more preferably 28 to 35% m/m. These fillers C are composed of polymer particles Cp and inorganic particles Ci, as previously defined. The polymer particles Cp represent 1 to 10% m/m, preferably 1 to 5% m/m, and yet more preferably 1 to 3% m/m of the total mass of the composition. Advantageously, the inorganic particles Ci represent 20 to 39% m/m, preferably 25 to 37% m/m, and yet more preferably 27 to 34% m/m of the total mass of the composition.

Particularly preferably, the compositions according to the invention comprise:
1 to 10% m/m, preferably 1 to 5% m/m, and yet more preferably 1 to 3% m/m polymer particles Cp of a high-impact or crystal polystyrene, which advantageously has a Mw in the range from 80 to 300 kg/mol, and preferably in the range from 100 to 250 kg/mol, as polymer particles Cp; and/or
20 to 39% m/m, preferably 25 to 37% m/m, and yet more preferably 27 to 34% m/m of calcium carbonate as the inorganic particles Ci.
   Of course the mass quantities of polymer particles Cp and inorganic particles Ci are selected in the above ranges, in order to have, overall, in the compositions according to the invention, 21 to 40% m/m, preferably de 26 to 38% m/m, and yet more preferably 28 to 35% m/m of fillers C.

In particular, such polymer particles Cp comprise, or are composed of, a mixture of a high-impact or crystal polystyrene and a polymer P1 chosen from polyvinyl chloride (PVC), acrylonitrile-butadiene-styrene copolymer (ABS), polycarbonates, polyethylene terephthalate (PET), with the high-impact or crystal polystyrene which has at least 85%, preferably at least 90%, and more preferably at least 95% of the mass of the polymer particles Cp which, preferably, come from waste recycling.

The compositions according to the invention comprise 40 to 70% m/m bitumen, preferably 50 to 65% m/m, and yet more preferably 55 to 65% m/m bitumen.

Optionally, but preferred for forming sealing membranes, in particular for a roof, the compositions according to the invention comprise 5 to 25% m/m, preferably 5 to 20% m/m and more preferably 7 to 18% m/m of one or more additional polymers P2, in particular, such as defined above. Preferably, the compositions according to the invention comprise 5 to 25% m/m, preferably 5 to 20% m/m, and more preferably 7 to 18% m/m of a styrene-butadiene-styrene block copolymer, preferably in branched or star-shaped form, atactic polypropylene, poly(ethylene-vinyl acetate) or a mixture of such polymers, as polymer P2.

Thus, the preferred compositions according to the invention comprise, or are composed of:
21 to 40% m/m, preferably 26 to 38% m/m, and yet more preferably 28 to 35% m/m of fillers C, composed of inorganic particles Ci and polymer particles Cp of high-impact or crystal polystyrene, the polymer particles Cp representing 1 to 10% m/m, preferably 1 to 5% m/m, and yet more preferably 1 to 3% m/m of the total mass of the composition and the inorganic particles Ci representing 20 to 39% m/m, preferably 25 to 37% m/m, and yet more preferably 27 to 34% m/m of the total mass of the composition;
40 to 70% m/m, preferably 50 to 65% m/m, and yet more preferably 55 to 65% m/m of bitumen;
5 to 25% m/m, preferably 5 to 20% m/m, and yet more preferably 7 to 18% m/m of one or more polymers P2.

In the preferred compositions according to the invention, the fillers C, the polymer particles Cp, the inorganic particles Ci, the additional polymer or polymers P2 and bitumen, presented as preferred will, of course, advantageously be used.

Also, the particularly preferred compositions according to the invention comprise, or are composed of:
21 to 40% m/m preferably 26 to 38% m/m, and yet more preferably 28 to 35% m/m of fillers C, composed of inorganic particles Ci of CaCO3 and polymer particles Cp of crystal or high-impact polystyrene, preferably from waste recycling; the polymer particles Cp representing 1 to 10% m/m, preferably 1 to 5% m/m, and yet more preferably 1 to 3% m/m of the total mass of the composition and the inorganic particles Ci representing 20 to 39% m/m, preferably 25 to 37% m/m, and yet more preferably 27 to 34% m/m of the total mass of the composition; preferably, said polymer particles Cp comprise, or are composed of, a mixture of polymers which is a mixture of a high-impact or crystal polystyrene and a polymer P1 chosen from, polyvinyl chloride (PVC), acrylonitrile-butadiene-styrene (ABS) copolymer, polycarbonates, polyethylene terephthalate (PET), with the high-impact or crystal polystyrene which has at least 85%, preferably at least 90%, and more preferably at least 95% of the mass of the polymer particles Cp; the polymer particles Cp preferably coming from waste recycling;
40 to 70% m/m, preferably 50 to 65% m/m, and yet more preferably 55 to 65% m/m of bitumen, preferably chosen from bitumens of grades 160/220 and 70/100 and the mixtures thereof;
5 to 25% m/m, preferably 5 to 20% m/m, and yet more preferably 7 to 18% m/m of a styrene-butadiene-styrene block copolymer, preferably in branched or star-shaped form, an atactic polypropylene, a poly(ethylene-vinyl acetate) or a mixture of such polymers.

Advantageously, the compositions according to the invention, are suitable for forming sealing membranes and, in particular, sealing membranes for a roof.

### Description of the Method for Manufacturing the Compositions

Conventionally, the mixture of bitumen and fillers C, or even of the one or more additional polymers P2, is carried out at a temperature ranging from 100 to 220° C., preferably ranging from 120 to 200° C., and more preferably ranging from 140 to 190° C. Advantageously, the mixture is produced at a temperature greater than or equal to 150° C., preferably greater than or equal to 160° C.

Such a mixture is produced under stirring, particularly for a duration of 5 minutes to 10 hours, preferably 10 minutes to 3 hours, more preferably 10 to 90 minutes, and yet more preferably 20 to 90 minutes. The mixing can be implemented by means of stirring producing a strong shear or stirring producing a weak shear. In particular, the mixture is produced under stirring at 200 to 2000 rpm, preferably 300 to 1500 rpm. The stirring is carried out in such a way as to facilitate the dispersion and good distribution of fillers in the bitumen, which will constitute the matrix of the composition, optionally in combination with the one or more additional polymers P2. The conditions are adjusted in order to lead to the obtaining of a homogeneous mixture. Conventionally, a person skilled in the art will adjust the time and power of the stirring, as well as the mixing temperature, in particular according to the bitumen, or else the one or more additional polymers P2, in order to have a molten mixture, and the size and quantity of fillers C. Conventionally, the mixing is carried out so as to promote a good distribution of C, or of the one or more additional polymers P2, in the final obtained bituminous composition.

Advantageously, when an additional polymer P2 is desired in the bituminous composition to be prepared, this is added to the bitumen, before the fillers C. Indeed the presence of the fillers C makes a good distribution of the additional polymer P2 within the bituminous matrix more difficult, if this is added after.

Regarding the polymer particles Cp and the inorganic particles Ci, composing the fillers C, these can be introduced together or separately. According to a preferred embodiment, the polymer particles Cp are introduced, before the inorganic particles Ci.

In particular polymer particles Cp having a D50 that is in the range from 10 to 300 μm, preferably in the range from 20 to 200 μm, and more preferably in the range from 30 to 150 μm and inorganic particles Ci having a D50 in the range from 10 to 300 μm, preferably in the range from 20 to 200 μm, and more preferably in the range from 30 to 150 μm, are introduced, together or separately, into a bitumen-based matrix or a matrix consisting of bitumen. The polymer particles Cp and the inorganic particles Ci that are introduced can, however, have the same or different size.

In particular, polymer particles Cp having a coefficient of variation CV, characterising their size dispersion, from 1.1 to 5, preferably from 1.1 to 4, and more preferably from 1.1 to 3 and/or inorganic particles Ci having a coefficient of variation CV, characterising their size dispersion, from 1.1 to 5, preferably from 1.1 to 4, and more preferably from 1.1 to 3 are introduced into a bitumen-based matrix or a matrix consisting of bitumen.

In general, and in a manner known to a person skilled in the art, the bitumen or mixture of bitumens used for manufacturing the composition is heated and stirred before incorporation of the other constituents of the composition. The constituents are, in general, introduced sequentially. Heating is maintained throughout the process, and the heating temperature can be modulated during the process. Stirring can be continuous or intermittently interrupted, if necessary, particularly during the introduction of inorganic particles Ci and/or can be modulated in intensity. In particular, the stirring can be greater during the introduction of certain constituents and, in particular, during the introduction of the inorganic particles Ci.

In the method according to the invention, one or more bitumen, fillers C, polymer particles Cp, and inorganic particles Ci, or even one or more polymers P2, corresponding to the descriptions given above in the corresponding part, are preferably used.

Of course, in the method, the quantities used of bitumen, fillers C, and therefore of polymer particles Cp, and inorganic particles Ci, or the one or more optionally present polymers P2, will be adjusted by a person skilled in the art in order to obtain the desired final quantities in the final composition, and in particular those mentioned in the preceding part relating to the compositions according to the invention.

The bituminous compositions that can be obtained by such a method are also an integral part of the invention.

### Sealing Membranes

Another object of the invention is a sealing membrane, in particular for a roof, comprising a layer formed of a composition according to the invention. Such a layer obtained by depositing a composition according to the invention, typically has a thickness of 2 to 10 mm, particularly 3 to 5 mm.

The obtaining of a layer from a composition according to the invention, in order to manufacture a sealing membrane, is carried out according to any suitable deposition technique. Before its application, it is preferable that the composition is a malleable paste and/or fluid and/or viscous paste, which requires heating. The application can be carried out manually, for example with a trowel, by coating or by spraying, directly on the support for which the sealing is to the ensured or on a fibrous material. Such a fibrous material can, for example, be made of glass fibres, polyamide fibres, polyester fibres and/or be in the form of a nonwoven material. Said fibrous material can partly incorporate the sealing membrane and play the role of a reinforcement.

The membrane can be produced directly on site or be manufactured beforehand. In the latter case, the membrane very often has a rollable character and can be in the form of a roll, facilitating its storage before use.

Another object of the invention is a sealing membrane, in particular for a roof, comprising a composition according to the invention, being at least partially impregnated with a fibrous material. Such a fibrous material can, for example, be made of glass fibres, polyamide fibres, polyester fibres and/or be in the form of a nonwoven material.

Another object of the invention is a sealing membrane, in particular for a roof, in the form of a single layer structure and comprising a layer formed of a composition according to the invention.

A sealing membrane for a roof, in the form of a multilayer structure, typically comprises an upper layer made of polymer material which is designed to reflect UV rays, a lower layer for sealing, which is designed to cover a roof, and a reinforcement arranged between said upper layer and said lower layer. The lower, sealing layer is therefore composed of a composition according to the invention. The reinforcement is, in particular, a previously described fibrous material.

Of course, all the preferences mentioned for the compositions according to the invention apply to the sealing membranes according to the invention, and, in particular, to the sealing membranes for a roof according to the invention.

### EXAMPLES

The following components were used:
a bitumen of grade 160/220 having a TBA of 38.4° C. and a penetrability at 25° C. of 197 1/10 mm,
CaCO3 particles, marketed by MEAC. These particles have a maximum size less than 90 μm.
two types of polymer particles from the same plastics waste based on high-impact polystyrene (denoted PS1 and PS2), from refrigerator waste. The difference between the particles PS1 and PS2 resides in the particle size. Their properties are given in Table 1 below.
an SBS block copolymer, marketed under reference D1184 ASM by Kraton.

TABLE 1

| | D50 (μm) CV | Composition | Mw (kg/mol) |
|---|---|---|---|
| | D100 (μm) | (¹H and ¹³C NMR) | of polystyrene |
| PS1 | N.D. | PS*/ABS | 170 |
| (Example 1 | | (10% m/m ABS) | |
| at 1% m/m) | | | |
| PS2 | 56 | PS/ABS | 170 |
| (Example 2 | CV = 2.2278 | (10% m/m ABS) | |
| at 3% m/m) | | | |

N.D. not determined, but in view of the sieving technique used for size selection, their size is between 125 and 250 μm, which means that their maximum size is less than or equal to 250 μm. The D50 was determined in accordance with the method previously described in the description.
*PS = high-impact polystyrene

The mass Mw was evaluated by GPC, using tetrahydrofurane (THF) as solvent THF, in a column at 25° C., with a refractometer detector. The calibration was carried out with 12 PS standards of masses 1.01 to 44800 kg/mol, purchased from Tosoh.

The performance of the compositions and membranes which were evaluated are:
the ring and ball temperature TBA, according to standard EN1427 (evaluated on the compositions),
the penetrability at 25° C. and 50° C. (which is more relevant for the bituminous compositions for membranes), according to standard EN 1426 (evaluated for the compositions),
the pliability when cold according to standard EN 1109 (evaluated on the membranes), which makes it possible to know the behaviour of a membrane at low temperatures and therefore to know its fracture point,
the remanence according to standard NFT 46009 (evaluated on the membranes), which makes it possible to know the residual deformation of a membrane after a stress at high deformation,
Brookfield viscosity CAP 2000+ at 180° C., with a velocity gradient of 50 s-1 and use of a mobile 7 with cone-plan geometry (evaluated on the compositions),
PAV ageing was carried under the following conditions: 21 bar air at 100° C., for 44 hours. Ring and ball temperature measurements, penetrability and pliability when cold have been repeated after such ageing.

Two compositions (examples 1 and 2) according to the invention were prepared as follows: one with polymer particles of polystyrene PS1, with the ratio of 1% m/m (example 1) and the other with polymer particles of polystyrene PS2, with a ratio of 3% m/m (example 2).

Compositions of example 1:
bitumen: 58% m/m,
CaCO3: 34% m/m,
PS1: 1% m/m,
SBS: 7% m/m.

Composition of example 2:
bitumen: 58% m/m,
CaCO3: 32% m/m,
PS2: 3% m/m,
SBS: 7% m/m.

These compositions were prepared as follows:

The bitumen was heated for 10 minutes to a temperature of 180° C. while stirring at 200 rpm, then the stirring was increased to 400 rpm and the SBS polymer was added (in order to eventually have 7% by mass of SBS polymer in the composition) slowly in order to promote its good dispersion. Once the SBS was introduced, the stirring was reduced to 200 rpm and held, for approximately 20 minutes at 180° C. The desired quantity of PS1 or PS2 was then introduced.

The stirring was then increased to 800 rpm. Then, the necessary quantity of CaCO3 was introduced, in order to eventually have, in the composition, 35% by mass of (CaCO3+PS1) or (CaCO3+PS2). The addition of CaCO3 caused air bubbles, the stirring was stopped intermittently in order to avoid splashes of hot bitumen. Once the addition of CaCO3 was completed, the stirring was reduced to 200 rpm and the mixture was stirred for 40 minutes at 190° C.

A membrane was then obtained by pouring the mixture onto a mould and drawing it using a previously heated blade, in order to eventually obtain a membrane of the same thickness of 2 mm.

The results obtained for the two compositions according to the invention were compared with those obtained with a reference composition which does not comprise inorganic fillers, i.e. 35% m/m CaCO3, and no polymer particles as filler.

Reference composition:
bitumen: 58% m/m,
CaCO3: 35% m/m,
SBS: 7% m/m.

The results are presented in Table 2 below.

TABLE 2

| | Reference | Example 1 | Example 2 |
|---|---|---|---|
| | (35% m/m CaCO3) | (1% PS1) | (3% PS2) |
| TBA (° C.) | 131 | 133 | 135.5 |
| TBA after PAV (° C.) | 112 | 113.5 | 114.5 |
| Penetrability at 25° C. | 46 | 44 | 43 |
| (1/10 mm) | | | |
| Penetrability at 50° C. | 97 | 93 | 91 |
| (1/10 mm) | | | |
| Penetrability at 25° C. | 25 | 24 | 22 |
| after PAV (1/10 mm) | | | |
| Penetrability at 50° C. | 84 | 85 | 88 |
| after PAV (1/10 mm) | | | |
| Cold pliability | −22 | −26 | −22 |
| Cold pliability | −8 | −6 | −6 |
| after PAV | | | |
| Remanence (%) for | 7.5 | 7.5 | 10 |
| an elongation of | | | |
| 200% | | | |
| Viscosity at 180° C. | 8.35 | 8.88 | 10.16 |
| (Pa · s) | | | |

These results show that the substitution of a part of the CaCO3 by particles made of high-impact polystyrene, coming from waste, has no effect on the investigated properties. In particular, the results obtained conform with EUatc (European Union for technical approval in construction) which corresponds to the recommendations to be met in order for the material used on building sites to be adequate. This reference is used for sealing membranes, in order to guarantee resistance to rain, wind and fire.

The results of this table also show that the penetrability at 50° C., which is associated with the walking resistance, is improved by the compositions according to the invention.

1. A bituminous composition comprising:
a bitumen-based matrix having fillers C that represent 21 to 40% of the total mass of the composition and that comprise inorganic particles Ci and polymeric particles Cp of crystal polystyrene or high-impact polystyrene, the mass of polymeric particles Cp representing 1 to 10% of the total mass of the composition and the mass of bitumen representing 40 to 70% of the total mass of the composition.

2. The composition according to claim 1, wherein the high-impact or crystal polystyrene of the polymeric particles Cp has a Mw in the range from 80 to 300 kg/mol, and preferably in the range from 100 to 250 kg/mol.

3. The composition according to claim 1, wherein the polymeric particles Cp comprise at least 85% by mass, preferably at least 90% by mass, and more preferably at least 95% by mass of high-impact or crystal polystyrene, in a mixture with one or more polymers P1, preferably chosen from polyvinyl chloride (PVC), acrylonitrile-butadiene-styrene copolymer (ABS), polycarbonates, polyethylene terephthalate (PET), and the polymeric particles Cp preferably coming from waste recycling.

4. The composition according to claim 1, further comprising one or more polymers P2, preferably chosen from plastomers and thermoplastics, and particularly thermoplastic elastomers, in particular chosen from copolymers with unsaturated blocks.

5. The composition according to claim 4, wherein the one or more polymers P2 are chosen from styrene-butadiene-styrene block copolymers, preferably in branch or star-shaped form, atactic polypropylene and poly(ethylene-vinyl acetate).

6. The composition according to claim 4, wherein the mass of one or more polymers P2 represents 5 to 25%, preferably 5 to 20% and, yet more preferably, 7 to 18% of the total mass of the composition.

7. The composition according to claim 1, wherein the inorganic particles Ci are particles of calcium carbonate, magnesium carbonate, magnesium hydroxide, calcium sulfate, barium sulfate, silica, clay, talc, mica, wollastonite, montmorillonite, zeolite, alumina, titanium oxide, magnesium oxide, zinc oxide or glass; particles of calcium carbonate being preferred.

8. The composition according to claim 1, wherein the mass of inorganic particles Ci represents 20 to 39%, preferably 25 to 37%, and yet more preferably 27 to 34% of the total mass of the composition.

9. The composition according to claim 1, wherein the D50 of the polymeric particles Cp and/or the D50 of the inorganic particles Ci is in the range from 10 to 300 μm, preferably in the range from 20 to 200 μm, and more preferably in the range from 30 to 150 μm.

10. The composition according to claim 1, comprising:
21 to 40% m/m, preferably 26 to 38% m/m, and yet more preferably 28 to 35% m/m of fillers C, comprising inorganic particles Ci and polymeric particles Cp of high-impact or crystal polystyrene, the polymeric particles Cp representing 1 to 10% m/m, preferably 1 to 5% m/m, and yet more preferably 1 to 3% m/m of the total mass of the composition and the inorganic particles Ci representing 20 to 39% m/m, preferably 25 to 37% m/m, and yet more preferably 27 to 34% m/m of the total mass of the composition;
40 to 70% m/m, preferably 50 to 65% m/m, and yet more preferably 55 to 65% m/m of bitumen;
5 to 25% m/m, preferably 5 to 20% m/m, and yet more preferably 7 to 18% m/m of one or more polymers P2 as defined in claim 4 or 5;
the % m/m being the percentage by mass relative to the total mass of the composition.

11. A method for preparing a composition according to claim 1, comprising mixing under heating of an assembly comprising:
bitumen, and
fillers C comprising inorganic particles Ci and polymeric particles Cp of high-impact or crystal polystyrene.

12. The method according to claim 11, wherein the mixing under heating is carried out at a temperature in the range from 100 to 220° C., preferably for 5 minutes to 10 hours and/or under stirring at 200 to 2000 rpm.

13. The method according to claim 11, wherein the mixing under heating is performed on an assembly further comprising one or more polymers P2 chosen from plastomers and thermoplastics and, particularly, thermoplastic elastomers, in particular chosen from copolymers with unsaturated blocks, and, yet more preferably, chosen from styrene-butadiene-styrene block copolymers, preferably in branched or star-shaped form, atactic polypropylene and poly(ethylene-vinyl acetate).

14. The method according to claim 13, comprising introducing into the bitumen said one or more polymers P2, before introducing, into the bitumen, inorganic particles Ci and polymeric particles Cp of high-impact or crystal polystyrene.

15. The method according to claim 11, comprising introducing into the bitumen inorganic particles Ci which have a D50 that is in the range from 10 to 300 μm, preferably in the range from 20 to 200 μm, and more preferably in the range from 30 to 150 μm and/or polymeric particles Cp of high-impact or crystal polystyrene which have a D50 in the range from 10 to 300 μm, preferably in the range from 20 to 200 μm, and more preferably in the range from 30 to 150 μm.

16. A sealing membrane, comprising a layer formed of a composition according to claim 1.

17. The sealing membrane according to claim 16, wherein the composition at least partially impregnates a fibrous material.

18. The sealing membrane according to claim 16 in the form of a multilayer structure.
